(19) United States
(12) Patent Application Publication
(10) Pub. No.: US 2015/0066509 A1
(43) Pub. Date: Mar. 5, 2015

(54) ELECTRONIC DEVICE AND METHOD FOR ENCRYPTING AND DECRYPTING DOCUMENT BASED ON VOICEPRINT TECHOLOGY

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: SHI-CHAO WANG, Wuhan (CN); WEN-TING PENG, Wuhan (CN); JIAN LI, Wuhan (CN); YI-HUNG PENG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/059,458

(22) Filed: Oct. 22, 2013

(30) Foreign Application Priority Data
Aug. 30, 2013 (CN) 201310385819X

(51) Int. Cl. G10L 17/00

(52) U.S. Cl. CPC G10L 17/00
USPC 704/246

(57) ABSTRACT

In a method for encrypting and decrypting a document based on a voiceprint recognition technology on an electronic device, an encryption key is generated and stored in a storage device of the electronic device. And a voiceprint is verified to determined whether the voiceprint is identical to a predefined voiceprint. if the voiceprint is identical to a predefined voiceprint, the encryption key is obtained from the storage device to encrypt a document. When the encrypted document is decrypted, a decryption key is generated to decrypt the encrypted document.

### BACKGROUND

1. Technical Field

The embodiments of the present disclosure relate to an electronic device and method for encrypting and decrypting a document based on voiceprint recognition technology.

2. Description of Related Art

Information security is important in modern society. Typical encryption methods have a wide variety of vulnerabilities and are easy to be cracked, resulting information disclosure, and causing irreparable damage to personal or commercial activity. Therefore, it is desirable to have an effective method for encrypting and decrypting information, to solve the above-mentioned problems.

### BRIEF DESCRIPTION OF THE DRAWINGS

FIG. 1 is a block diagram of one embodiment of an electronic device including an encryption and decryption system.

FIG. 2 is a block diagram of one embodiment of function modules of the encryption and decryption system in FIG. 1.

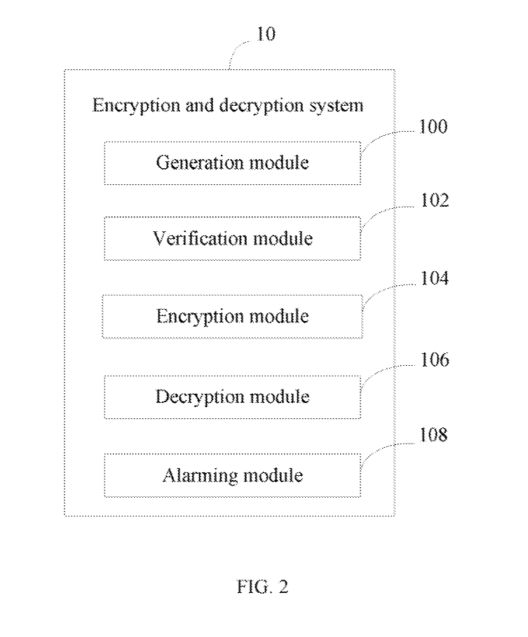

FIG. 3 is a flowchart of one embodiment of a method for encrypting a document based on a voiceprint recognition technology using the electronic device of FIG. 1.

FIG. 4 is a flowchart of one embodiment of a method for decrypting the document based on voiceprint recognition technology using the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

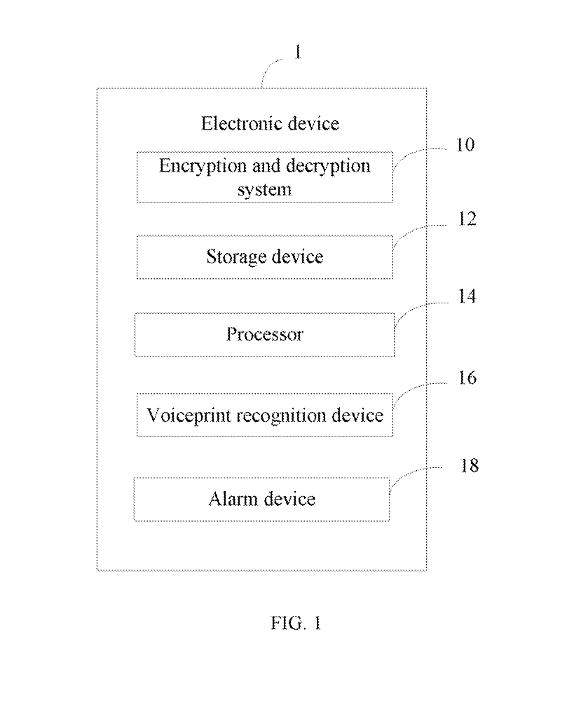

FIG. 1 is a block diagram of one embodiment of an electronic device 1 including an encryption and decryption system 10. The electronic device 1 further comprises a storage device 12, at least one processor 14, a voiceprint recognition device 16, and an alarm device 18. In the embodiment, the electronic device 1 may be a personal computer, a notebook computer, a cellular phone, a master production scheduler (MPS) device, or a personal digital assistant (PDA), for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The voiceprint recognition device 16 receives an inputted voiceprint(spectrogram of a voice) from an input device (such as a microphone) of the electronic device 1, and recognizes the inputted voiceprint to determine whether the inputted voiceprint is identical to a predefined voiceprint before encrypting or decrypting a document.

In one embodiment, the encryption and decryption system 10 includes a plurality of function modules which include computerized codes or instructions that can be stored in the storage device 12 and executed by the at least one processor 14 to provide a method for encrypting and decrypting a document based on a voiceprint recognition technology.

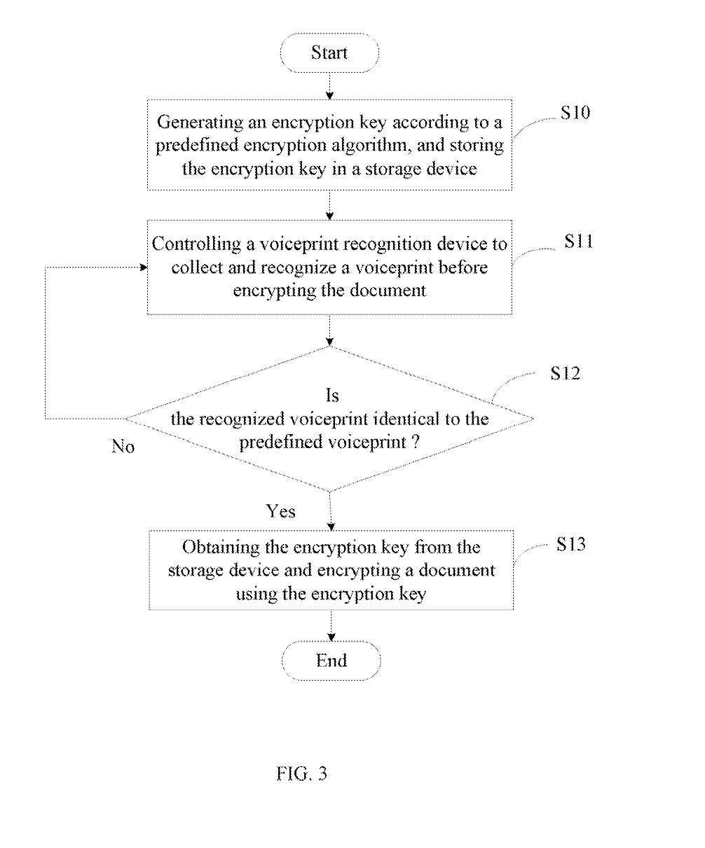

In one embodiment, the encryption and decryption system 10 may include a generation module 100, a verification module 102, an encryption module 104, a decryption module 106, and an alarming module 108. The modules may comprise computerized codes in the form of one or more programs that are stored in the storage device 12 and executed by the at least one processor 14 to provide functions for implementing the encryption and decryption system 10. The functions of the function modules are illustrated in FIG. 3 and described below.

FIG. 3 illustrates a flowchart of one embodiment of a method for encrypting a document based on a voiceprint recognition technology using the electronic device 1 of FIG. 1. Depending on the embodiment, additional steps may be added, others removed, and the ordering of the steps may be changed.

In step S10, the generation module 100 generates an encryption key according to a predefined encryption algorithm, and stores the encryption key in the storage device 12. In the embodiment, the predefined encryption algorithm may be a symmetric encryption algorithm or an asymmetric encryption algorithm.

In step S11, the verification module 102 controls the voiceprint recognition device 16 to collect and recognize a voiceprint before encrypting a document which may comprise some personal secrets of the user of the electronic device 1.

In step S12, the verification module 102 verifies whether the recognized voiceprint is identical to a predefined voiceprint stored in the storage device 1 in advanced. If the recognized voiceprint is identical to the predefined voiceprint, the verification is successful, and step S13 is implemented. Otherwise, if the recognized voiceprint is not identical to the predefined voiceprint, the verification is failed, and step S11 is repeated. In the embodiment, the predefined voiceprint is a voiceprint collected from the user of the electronic device 1 and stored in the stored device 12 in advance.

In step S13, the encryption module 104 obtains the encryption key from the storage device 12 and encrypts the document using the encryption key.

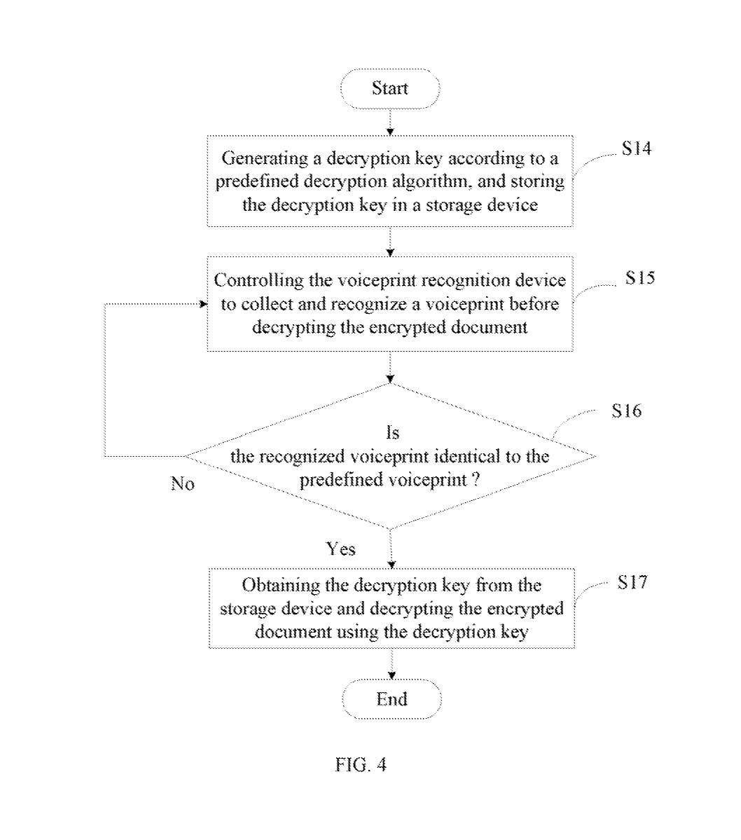

FIG. 4 illustrates a flowchart of one embodiment of a method for decrypting a document based on a voiceprint recognition technology using the electronic device 1 of FIG. 1. Depending on the embodiment, additional steps may be added, others removed, and the ordering of the steps may be changed.

In step S14, the generation module 100 generates a decryption key according to a predefined decryption algorithm, and stores the decryption key in the storage device 12. In the embodiment, the predefined decryption algorithm may be a symmetric decryption algorithm or an asymmetric decryption algorithm.

In step S15, the verification module 102 controls the voiceprint recognition device 16 to collect and recognize the voiceprint before decrypting an encrypted document.

In step S16, the verification module 102 verifies whether the recognized voiceprint is identical to the predefined voiceprint stored in the storage device 12. If the recognized voiceprint is identical to the predefined voiceprint, the verification is successful, and step S17 is implemented. Otherwise, if the recognized voiceprint is not identical to the predefined voiceprint, the verification fails, S15 is repeated.

In step S17, the decryption module 104 obtains the decryption key from the storage device 12 and decrypts the encrypted document using the decryption key.

In the embodiment, if the verification fails more than predefined times, the alarming module 108 further generates an alarm to prompt that the data of the document is stolen. The predefined times may be defined as three times according to the user, for example.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer program including instructions that, which executed by the at least one processor, causes the at least one processor to:
generate an encryption key according to a predefined encryption algorithm, and store the encryption key in the storage device;
control a voiceprint recognition device of the electronic device to collect and recognize a voiceprint of a user before encrypting a document;
verify whether the recognized voiceprint is identical to a predefined voiceprint stored in the storage device in advanced; and
obtain the encryption key from the storage device and encrypt the document using the encryption key if the recognized voiceprint is identical to the predefined voiceprint.

2. The electronic device according to claim 1, wherein the predefined encryption algorithm is a symmetric encryption algorithm or an asymmetric encryption algorithm.

3. The electronic device according to claim 1, wherein the computer program further causes the at least one processor to:
generate a decryption key according to a predefined decryption algorithm, and store the decryption key in the storage device;
control the voiceprint recognition device to collect and recognize the voiceprint before decrypting the encrypted document;
verify whether the recognized voiceprint is identical to the predefined voiceprint; and
obtain the decryption key from the storage device and decrypt the encrypted document using the decryption key if the recognized voiceprint is identical to the predefined voiceprint.

4. The electronic device according to claim 3, wherein the predefined decryption algorithm is a symmetric decryption algorithm or an asymmetric decryption algorithm.

5. The electronic device according to claim 3, wherein the computer program further causes the at least one processor to:
generate an alarm to prompt the user that the data of the document is being stolen, if the verification fails more than predefined times.

6. A method for encrypting a document based on a voiceprint recognition technology using an electronic device, the method comprising:
generating an encryption key according to a predefined encryption algorithm, and storing the encryption key in a storage device of the electronic device;
controlling a voiceprint recognition device of the electronic device to collect and recognize a voiceprint before encrypting the document;
verifying whether the recognized voiceprint is identical to a predefined voiceprint stored in the storage device in advanced; and
obtaining the encryption key from the storage device and encrypting the document using the encryption key if the recognized voiceprint is identical with the predefined voiceprint.

7. The method according to claim 6, wherein the predefined encryption algorithm is a symmetric encryption algorithm or an asymmetric encryption algorithm.

8. The method according to claim 6, further comprising:
generating a decryption key according to a predefined decryption algorithm, and storing the decryption key in the storage device;
controlling the voiceprint recognition device to collect and recognize the voiceprint before decrypting the encrypted document;
verifying whether the recognized voiceprint is identical to the predefined voiceprint; and
obtaining the decryption key from the storage device and decrypting the encrypted document using the decryption key if the recognized voiceprint is identical to the predefined voiceprint.

9. The method according to claim 8, wherein the predefined decryption algorithm is a symmetric decryption algorithm or an asymmetric decryption algorithm.

10. The method according to claim 8, further comprising:
generating an alarm to prompt the user that the data of the document is being stolen, if the verification fails more than predefined times.

11. A non-transitory computer-readable storage medium having stored thereon instructions being executed by a processor of an electronic device, causes the processor to perform a method for encrypting a document based on a voiceprint recognition technology using the electronic device, the method comprising:
generating an encryption key according to a predefined encryption algorithm, and storing the encryption key in a storage device of the electronic device;
controlling a voiceprint recognition device of the electronic device to collect and recognize a voiceprint before encrypting the document;
verifying whether the recognized voiceprint is identical to a predefined voiceprint stored in the storage device in advanced; and
obtaining the encryption key from the storage device and encrypting the document using the encryption key if the recognized voiceprint is identical to the predefined voiceprint.

12. The storage medium according to claim 11, wherein the predefined encryption algorithm is a symmetric encryption algorithm or an asymmetric encryption algorithm.

13. The storage medium according to claim 11, wherein the method further comprises:
generating a decryption key according to a predefined decryption algorithm, and storing the decryption key in the storage device;
controlling the voiceprint recognition device to collect and recognize the voiceprint before decrypting the encrypted document;
verifying whether the recognized voiceprint is identical to the predefined voiceprint; and
obtaining the decryption key from the storage device and decrypting the encrypted document using the decryption key if the recognized voiceprint is identical to the predefined voiceprint.

14. The storage medium according to claim 13, wherein the predefined decryption algorithm is a symmetric decryption algorithm or an asymmetric decryption algorithm.

15. The storage medium according to claim 13, wherein the method further comprises:
generating an alarm to prompt the user that the data of the document is being stolen, if the verification fails more than predefined times.
